(19) United States
(12) Patent Application Publication
(10) Pub. No.: US 2008/0105281 A1
(43) Pub. Date: May 8, 2008

(54) CLEANING PROCESS FOR IMPAIRED FILTERS

(76) Inventor: KEVIN CHARLES TAYLOR, Victoria (CA)

Correspondence Address: J. GORDON THOMSON, P.O. BOX 8865, VICTORIA, BC, V8V 3Z1, omitted

(21) Appl. No.: 11/923,527

(22) Filed: Oct. 24, 2007

Related U.S. Application Data
(60) Provisional application No. 60/857,198, filed on Nov. 7, 2006.

(51) Int. Cl. B08B 9/00

(52) U.S. Cl. 134/22.19; 134/22.1

(57) ABSTRACT

A cleaning process using aqueous liquid compositions for cleaning membrane filters used primarily in tubular backpulse liquid filtration systems in Kraft pulp mills for white liquor, green liquor and lime mud filtration and in chlor-alkali processing. The process removes silicate and aluminosilicate materials that reduce filtration efficiency with minimal damage to the membrane filter. The method consists of a first stage first liquid composition flush to remove soluble calcium compounds followed by a second stage second liquid composition flush that dissolves the silicate and aluminosilicate compounds and prevents reprecipitation of dissolved aluminum and silicon compounds in the filter membrane. The filters are then flushed by water.

### CROSS-REFERENCE TO RELATED APPLICATIONS

This patent application claims priority from U.S. Provisional Patent Application 60/857,198 filed in the United States Patent Office on Nov. 7, 2006 and entitled Cleaning Process for Membrane Filters Used in industrial Liquid Filtration Systems.

### BACKGROUND OF THE INVENTION

1. Field of the Invention

This invention relates to cleaning processes for impaired filters and more particularly a cleaning process for impaired tubular backpulse pressure filters used in industrial liquid filtration systems.

2. Description of Prior Art

Pressure filters are commonly used in the pulp and paper industry in tubular backpulse liquid filtration systems. These industrial filtration systems are used to filter white liquor, green liquor and lime mud wash fluids. As filtration efficiency decreases, these filters are normally cleaned by acid washing with a buffered acid solution such as sulfamic acid or dilute hydrochloric acid. Sulfamic acid solution will dissolve acid-soluble material such as calcium carbonate and other carbonate compounds that reduce filtration efficiency. An example of this type of filter is the GORE™ membrane filter socks used in tubular backpulse liquid filtration systems (Gore & Associates, Inc.). These membranes are typically made from porous PTFE polymers. Filter material can also be other materials such as woven polypropylene fibers. As filtration efficiency becomes impaired, these filters must be replaced, incurring significant cost and downtime.

Recently, Taylor and McGuffie (“Investigation of Non-Process Element Chemistry at Elk Falls Mill—Green Liquor Clarifier and Lime Cycle”, presented at the Pulp and Paper Technical Association of Canada PACWEST Conference, Jasper, AB, Canada, May 17-20, 2006) reported that the filtration efficiency of membrane filters used for white liquor filtration could be significantly reduced by silicate and aluminosilicate compounds. These compounds are not significantly removed by normal acid washing of the membrane filters.

In U.S. Pat. No. 5,277,819, a membrane filter cleaning process is outlined that removes protein and polysaccharide compounds from polyamide membranes.

In U.S. Pat. No. 4,802,990, a method for dissolving mineral salts is described. A mixture of phosphonic acids containing either sulfamic acid, oxalic acid, hydroxyacetic acid, 2-amino ethane sulfonic acid or fluoroboric acid and neutralized to pH 7.0, is described. In example IV of that patent, a calcite mineral deposit was quickly dissolved followed by a rapid re-precipitation of a gelatinous material. Such a re-precipitation reaction can cause additional plugging of membrane filter systems.

Numerous procedures are known for dissolving silicate-containing materials from well bores in the petroleum industry. For example, U.S. Pat. No. 1,990,969 uses solutions of hydrochloric acid and water-soluble fluoride salts. This avoids the surface handling of hydrofluoric acid solution. In U.S. Pat. No. 2,001,579 the corrosivity of hydrochloric acid and hydrofluoric acids is reduced by the addition of a corrosion inhibitor. In U.S. Pat. No. 2,050,931 a water-wetting agent is injected ahead of an aqueous solution of hydrochloric acid and hydrofluoric acid to improve the silicate dissolving ability of the treatment. In U.S. Pat. No. 2,367,350, a hydrochloric acid solution is injected ahead of a solution of hydrofluoric acid to remove multivalent cations from the region containing the silicate materials. This prevents damaging precipitation reactions. In U.S. Pat. No. 2,663,689, boric acid is dissolved in an aqueous hydrochloric acid-hydrofluoric acid solution to avoid precipitation of insoluble fluoride salts, when multivalent cations are encountered, or precipitation of gelatinous hydrofluorosilic acid, when the acidity of the solution is depleted.

### SUMMARY OF THE INVENTION

This invention can be applied to tubular backpulse pressure filters with or without a surface membrane present. Tubular backpulse pressure filters come in two types—one has a surface membrane, the other does not. Both are made from woven polypropylene fibers. This invention applies to both types of filters.

To resolve the problems identified with the prior art methods, this invention proposes a cleaning process for filters impaired by materials such as acid-soluble calcium compounds, acid insoluble calcium compounds, silicates, aluminosilicates and metal sulfides. In one embodiment of the invention the process comprises a first stage of treatment comprising a step where the filters are flushed with a first aqueous acid at a first predetermined temperature and for a first predetermined period of time. The first step results in the removal of acid-soluble divalent ions and calcium compounds. A second step is added comprising the step of flushing the filters with water for cleansing.

In another embodiment of the invention, the process is a multi-step process comprising the steps of flushing the filters with a first aqueous acid at a first predetermined temperature and for a first predetermined period of time. This results in the removal of acid-soluble calcium compounds. A second step comprises flushing the filters with a second aqueous acid at a second predetermined temperature for a second period of time. This second step results in the removal of silicates, aluminosilicates and metal sulfides. Then a third step comprises flushing the filters with water for cleansing.

In one embodiment of the invention said first aqueous acid is an organic acid or an inorganic acid.

In another embodiment of the invention the second aqueous acid is an organic acid containing fluoride ions. The fluoride ions may have a concentration of between 0.1% by wt. and 20% by wt.

In yet another embodiment of the invention the second aqueous acid is an inorganic acid containing fluoride ions having a concentration of between 0.1% by wt. and 20% by wt. The fluoride ions may be derived from an ammonium salt of hydrofluoric acid or from fluoboric acid.

In one embodiment of the invention the first aqueous acid or the second aqueous acid may be an emulsified acid.

In another embodiment of the invention there may be added a further step of adding a chelating agent to the first or the second aqueous acid for removing acid insoluble calcium compounds.

In yet another embodiment of the invention there may be added a further step of adding a wetting agent to improve contact between the first and aqueous acids and materials.

In one embodiment of the invention the first and second acids are organic derived from a group of organic acids comprising sulfamic acid, acetic acid, hydroxyacetic acid and citric acid. The first and second acids may have a concentration between 0.5% by wt. and 15% by wt.

In yet another embodiment of the invention the first and second acids comprise fluoboric acid at a concentration of between 1% by wt. and 20% by wt.

In one embodiment of the invention the first predetermined temperature and said second predetermined temperature are between 20° C. and 95° C. In a preferred embodiment the first and second predetermined temperatures are between 25° C. and 60° C.

In another embodiment of the invention the first and second predetermined times are between 0.1 hours and 0.5 hours.

In still another embodiment of the invention first step and the second step further comprise the step of adding a corrosion inhibitor.

### DETAILED DESCRIPTION

The following description is provided for the purpose of describing examples and specific embodiments of the invention only and is not intended to exhaustively describe all possible examples and embodiments of the invention.

This invention defines a cleaning process for industrial tubular backpulse pressure filters used primarily in Kraft pulp mills for white liquor, green liquor and lime mud filtration, and in chlor-alkali processing. The invention prolongs the use of the porous filter membranes by permitting non-destructive cleaning to remove silicate and aluminosilicate materials that reduce filtration efficiency. This invention can be applied to tubular backpulse filters with or without a surface membrane present.

The process can be a single stage treatment comprising a first stage treatment followed by a water flush or a two stage treatment comprising a first and second stage treatment. The purpose of the first stage treatment is to remove any acid-soluble divalent ions (such as calcium). If a second stage treatment is also used, then the removal of the acid-soluble divalent ions prevents the formation of insoluble fluoride salts during the second stage of the treatment.

The first stage contains an aqueous solution containing an inorganic acid or an organic acid present in sufficient quantity to remove acid-soluble material. Acid concentrations are 0.1 to 30 wt % but more preferably 1 to 15 wt %. An organic acid such as sulfamic acid at a concentration of 5 to 10 wt % is preferred. Treatment temperature is from 20 to 95° C. but most preferably from 20 to 60° C. The first stage may contain corrosion inhibitors, chelating agents or water-wetting agents. The purpose of the corrosion inhibitor is to reduce corrosion in the process equipment. The chelating agent is required to remove calcium-containing compounds that are not readily soluble in the acid itself. These include hydroxylapatite (calcium phosphate) and metal sulfides. A water-wetting agent is used to improve the contact between the acid and the solids present in the filter.

The second stage is identical in composition to the first stage but also contains from 0.1 to 10 wt % fluoride in the form of HF or a fluoride salt. The fluoride ion concentration is most preferably 1 to 5 wt %. In a preferred embodiment, the fluoride salt is an ammonium salt of hydrofluoric acid. However, it can comprise one or more of substantially any fluoride salt that is relatively water-soluble. The second stage may also contain the organic acid citric acid or boric acid to reduce the precipitation of aluminum-containing compounds. Treatment temperature is from 25 to 95° C. but most preferably from 25 to 60° C. The second stage may contain corrosion inhibitors, chelating agents or water-wetting agents as detailed in the previous paragraph. Following the treatment, the filter is flushed with water.

Although this description has much specificity, these should not be construed as limiting the scope of the invention but as merely providing illustrations of some of examples of the invention. Thus the scope of the invention should be determined by the appended claims and their legal equivalents rather than by the examples given herein.

What is claimed is:

1. A cleaning process for filters impaired by materials comprising acid-soluble calcium compounds, acid insoluble calcium compounds, silicates, aluminosilicates and metal sulfides, said cleaning process comprising the following:
a. A first step wherein said filters are flushed with a first aqueous acid at a first predetermined temperature and for a first predetermined period of time, said first step resulting in the removal of said acid-soluble calcium compounds; and,
b. A second step wherein the filters are flushed with water for cleansing.

2. A cleaning process for filters impaired by materials comprising acid-soluble calcium compounds, acid insoluble calcium compounds, silicates, aluminosilicates and metal sulfides, said cleaning process comprising the following:
a. A first step wherein said filters are flushed with a first aqueous acid at a first predetermined temperature and for a first predetermined period of time, said first step resulting in the removal of said acid-soluble calcium compounds;
b. A second step comprising flushing the filters with a second aqueous acid at a second predetermined temperature for a second period of time, the additional step resulting in the removal of said silicates and said aluminosilicates; and,
c. A third step wherein the filters are flushed with water for cleansing.

3. The cleaning process of claim 1 or 2, wherein said first aqueous acid is an organic acid.

4. The cleaning process of claim 3, wherein the first aqueous acid is an inorganic acid.

5. The cleaning process of claim 2, wherein the second aqueous acid is an organic acid containing fluoride ions having a concentration of between 0.1% by wt. and 20% by wt., and wherein said fluoride ions are derived from an ammonium salt of hydrofluoric acid.

6. The cleaning process of claim 2, wherein the second aqueous acid is an organic acid containing fluoride ions having a concentration of between 0.1% by wt. and 20% by wt., and wherein said fluoride ions are derived from fluoboric acid.

7. The cleaning process of claim 2, wherein the second aqueous acid is an inorganic acid containing fluoride ions having a concentration of between 0.1% by wt. and 20% by wt., and wherein said fluoride ions are derived from an ammonium salt of hydrofluoric acid.

8. The cleaning process of claim 2, wherein the second aqueous acid is an inorganic acid containing fluoride ions having a concentration of between 0.1% by wt. and 20% by wt., and wherein said fluoride ions are derived from fluoboric acid.

9. The cleaning process of claim 1, further comprising the addition of a chelating agent to said first aqueous acid for removing said calcium compounds and metal sulfides.

10. The cleaning process of claim 2, further comprising the addition of a chelating agent to said first aqueous acid for removing said calcium compounds and metal sulfides.

11. The cleaning process of claim 1, further comprising the addition of a wetting agent to the first aqueous acid to improve contact between the first aqueous acid and said materials.

12. The cleaning process of claim 2, further comprising the addition of a wetting agent to the aqueous acid to improve contact between the aqueous acid and said materials.

13. The cleaning process of claim 3, wherein the first aqueous acid and the second aqueous acid are organic acids derived from a group of organic acids comprising sulfamic acid, acetic acid, hydroxyacetic acid and citric acid, and further wherein the first aqueous acid and the second aqueous acid have a concentration between 0.0% by wt. and 15% by wt.

14. The cleaning process of claim 1, wherein said first predetermined temperature is between 20° C. and 95° C.

15. The cleaning process of claim 2, wherein the first and second predetermined temperatures are between 20° C. and 95° C.

16. The cleaning process of claim 2, wherein said first predetermined time and said second predetermined time are between 0.1 hours and 0.5 hours.
